(19) United States
(12) Patent Application Publication
(10) Pub. No.: US 2023/0083979 A1
(43) Pub. Date: Mar. 16, 2023

(54) METHOD AND SYSTEM FOR SECURE BOOT AND RMA INTERVENTION

(71) Applicant: Ampere Computing LLC, Santa Clara, CA (US)

(72) Inventors: Phil MITCHELL, San Jose, CA (US); Harb ABDULHAMID, Raleigh, NC (US); Kha NGUYEN, San Jose, CA (US)

(21) Appl. No.: 17/472,259

(22) Filed: Sep. 10, 2021

(51) Int. Cl. G06F 21/57; G06F 21/54; G06F 21/79; G06Q 10/08

(52) U.S. Cl. CPC G06F 21/575; G06F 21/572; G06F 21/54; G06F 21/79; G06Q 10/0837

(57) ABSTRACT

A system and method is provided that enables a processor to undergo RMA after being in a secured operating state, where the secure state includes hardware disabling of test access ports and debug ports during a boot process. The apparatus providing this computer security at power-on or boot-up may have at least two one-time programmable indicators, a bootstrap controller that controls at least two boot-time switches and reads the one-time programmable indicators, and a read only memory storing at least one instruction. The bootstrap controller calculates an operating state such as a secure state or RMA state based on the at least two one-time programmable indicators. The bootstrap controller then enables or disables an execution of the at least one instruction or enables or disables a hardware port based on the operating state. The bootstrap controller may provide switching between RMA and secure states via sequential one-time programming of indicators.

### BACKGROUND

### I. Field of the Disclosure

The technology of the disclosure relates generally to a secure boot process and associated hardware elements.

### II. Background

Recent hardware and firmware exploits of cloud computing assets have exposed the vulnerability of the boot process of a computer or server to persistent and undetectable malware. These vulnerabilities manifest at various points in the boot process and exploit various ports used for testing and debug early in the implementation. Accordingly, the security of a chip, processor or central processing unit (CPU) has become an important part of device and cloud security.

In conventional implementations, a boot process begins with a launch of a basic input/output system (BIOS) which can serve as a miniature operating system. The beginnings of the boot process can allow for various interventions via hardware to test, debug, update, or read various fundamental hardware and firmware elements of the chip. These hardware interventions include scans of the integrity of the hardware and circuitry via the Joint Test Action Group (JTAG) protocol. The hardware and firmware can be debugged and analyzed via various debug ports. Depending on the size and sophistication of the chip, the available hardware access may vary. In many cases regardless of implementation, these testing and debug capabilities leave the chip vulnerable to attack.

More recently, chip suppliers have attempted to harden chips against attack by permanently disabling the test and debug ports of production chips so that at no part of the boot process are these ports accessible. Alternatively, the access to these ports at boot may rely on authentication certificates being delivered at certain points in the boot process. The permanent disabling, however, prevents an assessment of hardware failures for returned chips, and the authentication certificate access modes are still subject to attack. Furthermore, full debug capability needs to be available to process a returned merchandise authorization (RMA) for a chip returned for defects. Accordingly, a boot security process is needed that enables hardware disabling of test and debug access but also enables later analysis for RMA processes.

### SUMMARY

The following presents a simplified summary in order to provide a basic understanding of some aspects described herein. This summary is not an extensive overview of the disclosed subject matter. It is intended to neither identify key nor critical elements of the disclosure nor delineate the scope thereof. Its sole purpose is to present some concepts in a simplified form as a prelude to the more detailed description that is presented later.

In an example implementation, an apparatus for computer security at power-on may have at least two one-time programmable (OTP) indicators including a first programmed OTP indicator, a bootstrap controller component that controls at least two boot-time switches, and a read only memory storing at least one instruction. The bootstrap controller component may calculate an operating state based on the at least two one-time programmable indicators. The bootstrap controller component enables or prevents/disables an execution of the at least one instruction based on the operating state.

The at least two one-time programmable indicators of the apparatus may be grouped into at least a first subset and a second subset, and the first subset may be programmed and the second subset may be available for one-time programming. The first programmed OTP indicator may be programmed to enable the bootstrap controller component to receive voltage first (initialize) at power-on for entering a boot process. The second subset of the at least two one-time programmable indicators may include returned merchandise authorization (RMA) state indicators and security state indicators. The RMA state indicators and the security state indicators may control, via first logic gates, access to debug ports and test access ports for a returned merchandise authorization (RMA) process.

The bootstrap controller component may disable the execution of the at least one instruction (e.g., JTAG port authorization) based on the operating state, where the operating state is indicated by the at least two one-time programmable indicators. The at least two one-time programmable indicators may be connected to logic gates, the logic gates may be arranged such that a first programming of a first one-time programmable indicator of the at least two one-time programmable indicators is read by the bootstrap controller component as a first state (e.g., security operating state) of the operating state and a second programming of a second one-time programmable indicator of the at least two one-time programmable indicators is read by the bootstrap controller component as a second state (e.g., RMA state) of the operating state, and a third programming of a third one-time programmable indicator of the at least two one-time programmable indicators is read by the bootstrap controller component as the first state, the third programming being after the second programming. The at least two one-time programmable indicators may be electronic fuses or the like.

In an example implementation, the apparatus may include an interface to one or more test access ports, and a second one-time programmable indicator of the at least two one-time programmable indicators enables or disables the interface to the one or more test access ports. Furthermore, the execution of the at least one instruction of the read only memory may verify at least one certificate for authenticating firmware code or provides at least one certificate for authenticating firmware code or overriding the debug state.

In an example implementation, a method for ensuring computer security at power-on may include reading at least two one-time programmable (OTP) indicators including a first programmed OTP indicator, determining an operating state for a bootstrap controller component based on the at least two one-time programmable indicators, and executing at least one instruction based on the operating state (e.g. security state or RMA state), where the at least one instruction is stored in read-only memory (ROM). The at least two one-time programmable indicators may be grouped into at least a first subset and a second subset, the first subset being programmed and the second subset being available for one-time programming. The at least one instruction stored in ROM may be firmware and the at least one instruction may be signed or authenticated by one or more certificates. The at least one instruction may begin a boot process on the bootstrap controller component to initiate a boot process.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and novel features will become apparent from the following detailed description when considered in conjunction with the drawings.

### BRIEF DESCRIPTION OF THE DRAWINGS

FIG. 1 is a diagram of a system on a chip (SoC) according to an implementation;

FIG. 2 is a diagram of a system controller processor of the SoC according to an implementation;

FIG. 3 is a diagram of a trust management module (TMM) within an SMpro processor according to an implementation;

FIG. 4 is a flow chart of a early portion of a boot process according to an implementation;

FIG. 5A is a diagram of the bootstrap controller within the TMM according to an implementation;

FIG. 5B is a circuit diagram of portion of the bootstrap controller according to an implementation;

FIG. 5C is a circuit diagram of portion of the bootstrap controller according to an implementation;

FIG. 5D is a circuit diagram of portion of the bootstrap controller according to an implementation;

FIG. 6 is a flow chart of intervention points and state changes for boot parameters of a processor according to an implementation; and

FIG. 7 is a table illustrating state changes of various boot parameters via one-time indicators according to an implementation.

### DETAILED DESCRIPTION OF THE DRAWINGS

The disclosure herein is described with reference to the drawings, wherein like reference numerals are used to refer to like elements throughout. In the following description, for purposes of explanation, numerous specific details are set forth in order to provide a thorough understanding of the subject innovation. It may be evident, however, that various disclosed aspects can be practiced without these specific details. In other instances, well-known structures and devices are shown in block diagram form in order to facilitate describing the subject innovation.

The word “exemplary” is used herein to mean “serving as an example, instance, or illustration.” Any implementation described herein as “exemplary” is not necessarily to be construed as preferred or advantageous over other embodiments. Likewise, the term “implementation” does not require that all implementations include the discussed feature, advantage, or mode of operation.

The terminology used herein describes particular implementations only and should not be construed to limit any implementations disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art will further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

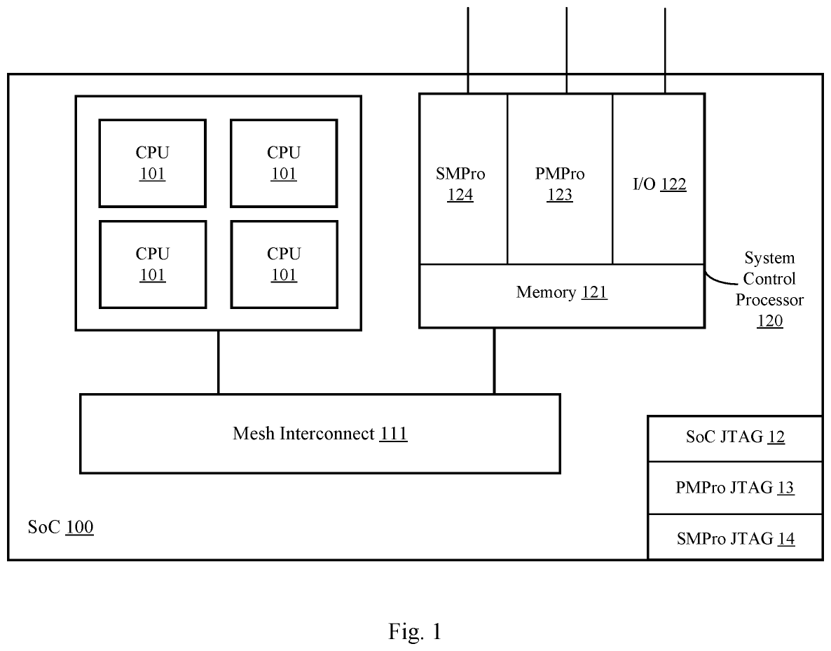

In FIG. 1, a system on a chip (SoC) 100 is illustrated with a set of central processing units (CPUs) 101 and a system controller processor that handles many of the utility functions of the SoC 100. The SoC 100 may include more than the illustrated four CPUs (e.g., 50 CPUs, 80 CPUs, or 120+ CPUs). The processors cores or CPUs 101 are connected to system control processor 120 via a mesh interconnect 111 that forms a high speed bus connecting each of the CPUs 101 to each other and connecting to other on chip resources including memory (e.g., L3 cache), PCIe interfaces, I2C bus connections off chip, and other resources. Specifically, the mesh interconnect 111 may individually connect to the SMpro processor 124, the PMpro processor 123, input/output (I/O) ports 122 and memory 121 of the system control processor 120. The mesh interconnect 111, an I2C interface, or other connections may connect the system control processor 120 to the SoC JTAG ports and firmware 12, to the PMpro JTAG ports 13, and SMPro JTAG ports and firmware 14.

The PMpro processor (or sub-processor) 123 may perform the power management for the SoC 100 and may connect to one or more voltage regulators (VR) that provide power to the SoC 100. The PMpro processor 123 may receive voltage readings, power readings, and/or thermal readings and may generate control signals (e.g. dynamic voltage and frequency scaling— DVFS) to be sent to the voltage regulators. The PMpro processor 123 may also report power conditions and throttling to an operating system or hypervisor running on the SoC 100. The PMpro processor 123 may provide the power for boot and may have specific power throttling and specific power connections for boot power to the system control processor (SCP) 120 and/or the SMpro processor 124. The PMpro processor 123 may receive power on control signals, voltage ramp signals, and other power control from the system control processor 120 and/or the SMpro processor 124 during boot up as hardware and firmware become activated on the SoC 100. These power-up processes and power sequencing may be automatic or may be linked to events occurring at or detected by the SMpro processor 124 and/or the PMpro processor 123.

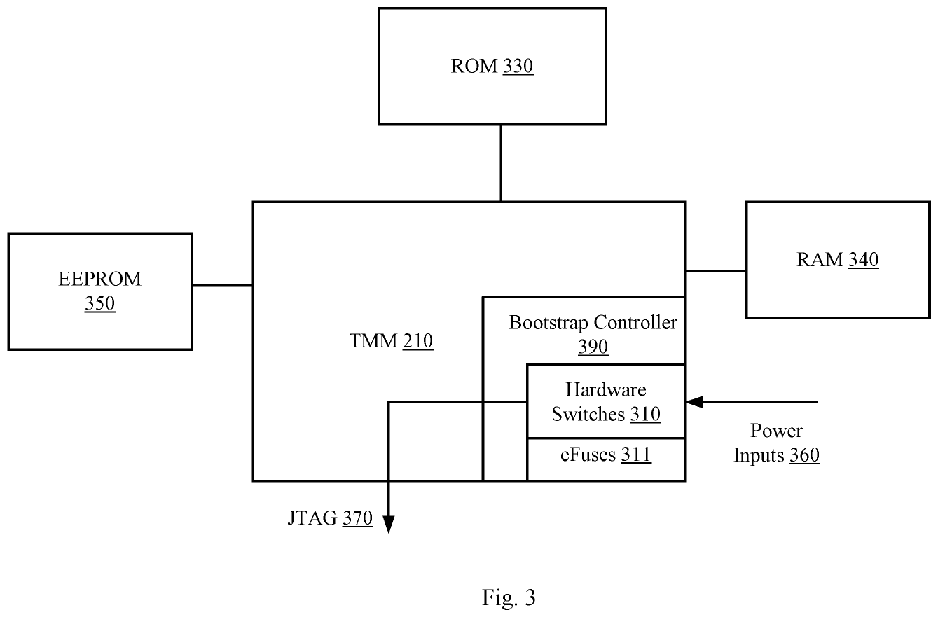

The SMpro processor (or sub-processor) 124 may include a bootstrap controller 390 (as will be illustrated with respect to FIG. 3) and an I2C controller or other bus controller. The SMpro processor 124 may communicate with on-chip sensors, a baseboard management controller (BMC) off chip, and other external systems to provide control signals to external systems. The SMpro processor 124 may perform error handling and crash recovery for CPUs of the SoC 100 and may perform power failure detection, recovery, and other fail safes for the SoC 100. The SMpro processor 124 manages the boot process and may include ROM and EPROM for safely storing firmware for controlling and performing the boot process. In addition, the SMpro processor 124 may store and execute the BIOS (if present) for the SoC 100. Thus, the SMpro processor 124 is responsible for the boot up of the SoC 100 and security features may be advantageously located on the SMpro processor 124.

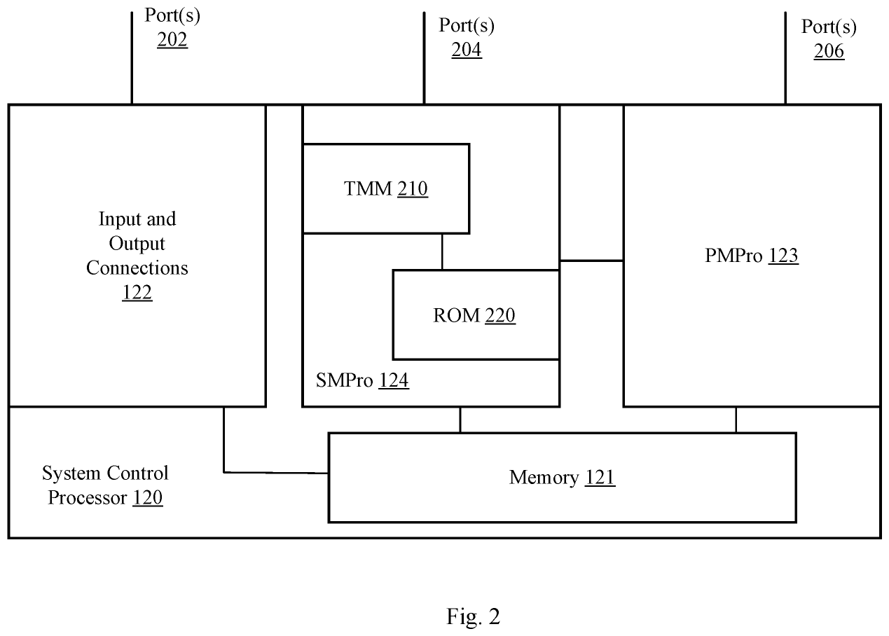

In FIG. 2, the system control processor (SCP) 120 is illustrated in more detail. The input and output (I/O) connections 122 may connect over ports 202 to external systems and memory of the SoC 100 and connect to on-board memory 121. The SCP 120 may use the I/O connections to interface with a base board management controller or other management systems for the SoC 101 and/or to the network of the cloud platform (e.g. gigabit ethernet, PCIe, or fiber). The system control processor 120 may perform scaling, balancing, throttling, and other control processes to manage the CPUs 101, associated memory controllers, and mesh interconnect 111 of the SoC 100. The PMpro processor 123 may connect to the shared memory 121, connect to the SMpro processor 124, and connect to external systems (e.g., VRs) via ports 206, and may supply power to each via power lines.

The SMpro processor 124 may connect to one or more off-chip systems as well via ports 204 and/or may connect to off-chip systems via the I/O connections 122. The SMpro processor 124 may include on-board ROM 220 (or EPROM) and a trust management module (TMM) 210. The TMM 210 may operate as hardware or firmware or a combination thereof. The shared memory 121 may be on-board RAM or secured RAM which can be trusted by the TMM 210 after an integrity check or certificate check. Indeed, the components of the SoC 100 may be divided into trusted components and non-trusted components, where the trusted components may be verified by certificates in the case of software components, or are pure hardware components so that at boot the TMM 210 may ensure that the boot process is secure.

In FIG. 3, the trust management module (TMM) 210 is illustrated with associated and connected resources of the SMpro processor 124 and/or the system control processor (SCP) 120. Specifically, the TMM 210 may connect to EEPROM (or EPROM) 350, ROM (or immutable ROM) 330, and RAM 340 of the SMpro processor 124 and/or the system control processor (SCP) 120. The TMM 210 may receive direct power inputs of a given voltage for boot via power inputs 360 from the PMpro processor 123. The TMM 210 may include a bootstrap controller 390 that may include dedicated hardware and firmware to perform the initial stages of the boot process before passing the boot operation onto secure ROM code and RAM BIOS processes.

The bootstrap controller 390 may include hardware switches 310 which may be embodied as logic gates (e.g. OR, XOR, NOR, AND, NAND), semiconductor switches, checksum functions, and other control logic in silicon. These hardware switches 310 may be the first components on the SoC 100 to be powered-on apart from (or after) the PMpro processor 123. The hardware switches 310 may read efuses 311 which may operate as immutable ROM and/or hardware coded values. The hardware switches 310 may determine whether access to the JTAG ports 370 should be granted or denied. That is, hardware switches 310 may enable or disable the SoC JTAG ports and firmware 12, the PMpro JTAG ports and firmware 13, and SMPro JTAG ports and firmware 14 of the SoC 100. The hardware switches 310 together with efuses 311 may control access (i.e., enable/disable) to debug ports and debug reads of ROM 330 and may embed parameters that define an operating state of the TMM 210 upon boot.

The TMM 210 may access various types of memory based on the security risk and stage of the boot. For instance, before security processes may be activated the TMM 210 may operate based on immutable ROM, efuses 311, and ROM 330. Once more advanced operations are running to check the validity of code and provide software-level security measures, then the TMM 210 may then access RAM 340 or EEPROM 350 for boot functions. The TMM 210 may also output authentication failure flags or indicators and/or boot failure indicators to the baseboard management controller off-chip in the event that errors occur. The efuses 311 may provide the necessary instructions for fail over or secure boot options that enable external re-programming of the EEPROM 350 to correct errors. Upon a successful authentication and power-on of the hardware switches 310, the bootstrap controller 390 or hardware switches 310 may output a particular boot state that is based on the efuses 311. The TMM 210 may use/read this boot state to enable or disable functions and may operate different ROM/EEPROM/RAM code/instructions based on the boot state.

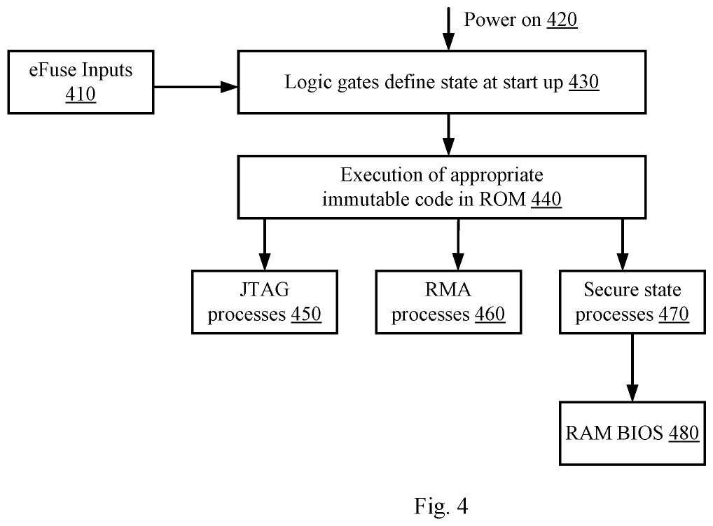

In FIG. 4, the first few steps of the boot process as begun on the boot strap controller 390 are illustrated. The power on 420 of the bootstrap controller 390 may include a current flow through the efuses 311 to generate efuse inputs 410 to the hardware switches 310. The logic gates define state at start up at 430 based on the efuse inputs 410. The defined state may be an RMA state, a secure state, a debug state, or a failure state. A failure state may output a single indicator of boot fail. If the initial hardware switches 310 and efuses 311 check out, then the single indicator may output or indicate a boot success. In addition to mere success/failure, the hardware switches may define the operating state for the remainder of the boot process (e.g. secure state, RMA state, etc.) including ROM instructions.

The execution of appropriate immutable code or instructions in ROM at 440 may be based on the defined state from 430 and access JTAG processes 450 in ROM or RMA processes 460 in ROM or secure state processes 470 in ROM. An operating state defined by the efuses 311 and efuse inputs 410 may be processed by activation logic within the bootstrap controller 390 such that the appropriate immutable code is executed at 440. In addition, based on the efuse inputs 410, if a secure state is defined, then one or more secure state parameters may be read from the efuse inputs 410 together with the state so as to customize the secure state. The JTAG processes 450 or RMA processes 460 or secure state processes 470 need not be exclusive of each other based on the defined state at 440. Instead, the defined state at 440 may indicate that JTAG processes 450 and secure state processes 470 may be activated or executed, for example.

After the execution of the appropriate ROM and/or EPROM instructions based on the defined secure state of the secure state processes 470, the bootstrap controller 390 may begin execution of the BIOS in RAM at 480 so that secure/trusted portions of the rest of the SoC 100 may be booted up. The BIOS may be executed in shared memory 121 of the system control processor 120 or the on-board RAM of the SMpro processor 124. The power-up sequence and execution sequence of FIG. 4 provides for ways to disable less secure processes (e.g. JTAG processes 450) via hardware that cannot be hacked or physically cracked.

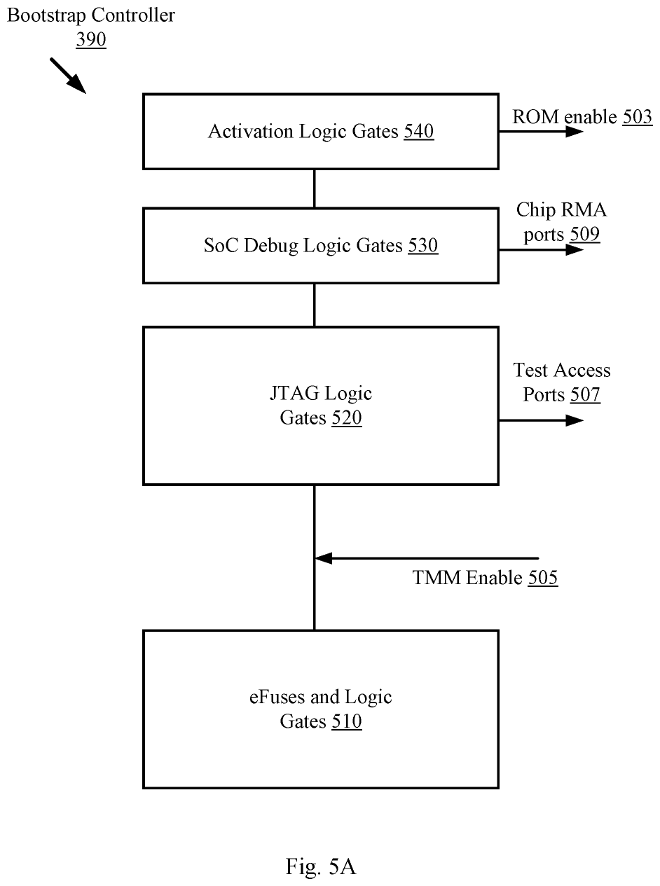

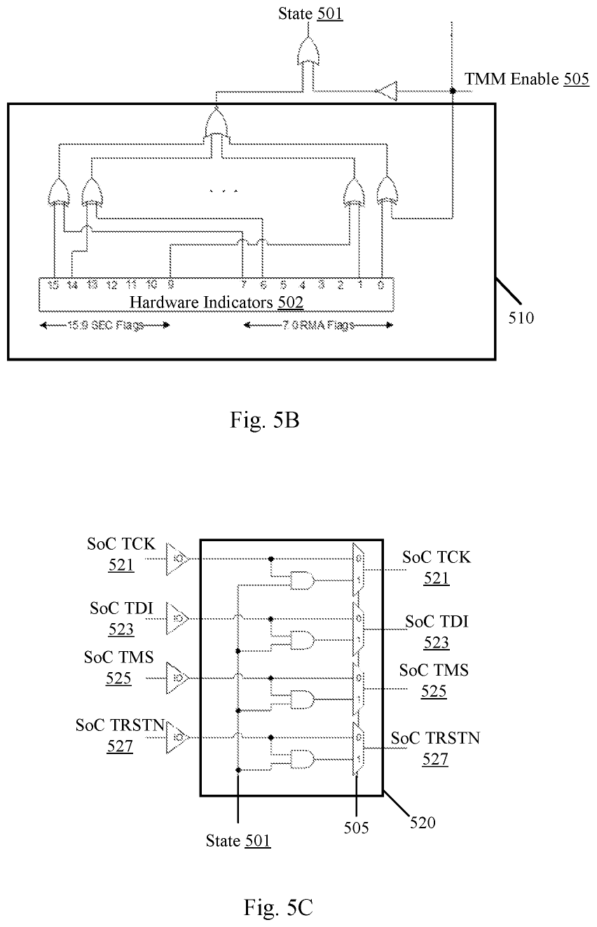

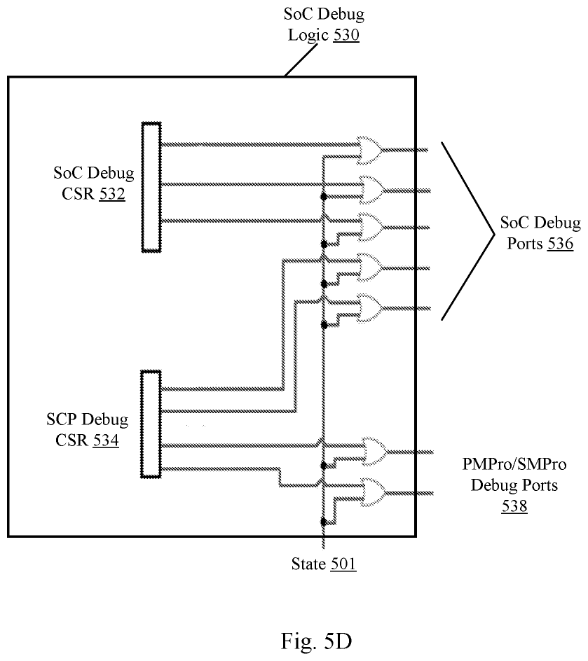

In FIG. 5A, an overview of the hardware logic blocks that form the bootstrap controller 390 are illustrated. At power on at 420, the efuses and logic gates 510 may be the first to be initialized (receive voltage at turn on) and receive clock signal and may define a state based on the efuses. The operating state may also incorporate a TMM enable flag 505 that may be encoded as an efuse and blown at completion of manufacturing. The defined operating state and TMM enable flag 505, as read by the bootstrap controller 390, then flow to the JTAG logic gates 520, the SoC debug logic gates 530, and the activation logic gates 540. At each of the blocks of logic gates 520-540 the operating state may activate or deactivate associated ports. Additional efuses or one-time programmable elements may be provided as a part of the secure state to provide additional parameters to the bootstrap controller 390 including anti-roll back, key revocation, thermal protection bits, and warranty bits. These parameters may be programmed during provisioning.

In particular, the JTAG logic gates 520 may compare an input operating state with a certificate and/or enable logic for that operating state and as a result may enable or disable test access ports 507 of the SoC 100. The SoC debug logic gates 530 may compare an input operating state with a certificate and/or enable logic for that operating state and as a result may enable or disable chip RMA ports 509 of the SoC 100. For example, an RMA state output by efuses and logic gates 510 may activate or enable test access ports 507 and RMA ports 509. A secure state output by efuses and logic gates 510 may activate or enable specific ROM instructions via ROM enable 503 after processing by the activation logic gates 540.

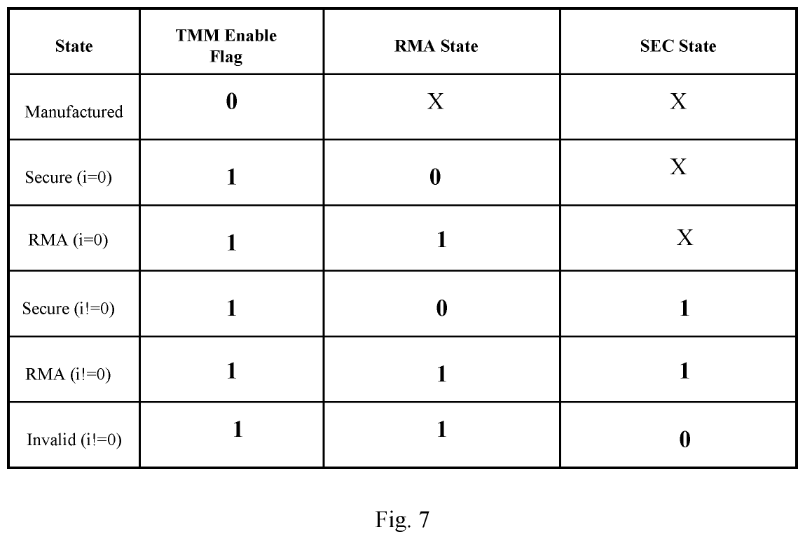

In FIG. 5B, the efuses and logic gates 510 according to an implementation are illustrated. These efuses may alternatively be any one-time programmable indicator. A subset of the efuses are hardware indicators 502 which form fifteen bits of binary indicators— RMA flags 0-7 and SEC flags 9-15. In total, two bytes or 16 bits may be used. The hardware indicators 502 are connected to XOR gates as inputs such that the lowest RMA flag is compared with TMM enable 505, the next-lowest RMA flag is compared with the lowest SEC flag, and so on, with the highest SEC flag being compared with the highest RMA flag. A blown or TRUE (1) value for an RMA flag may indicate an RMA state unless more SEC flags are blown resulting in a final TRUE state output from the SEC side of the hardware indicators 502 to be output as state 501. Additional XOR gates connect the other hardware indicators (i.e. 10-13 and 2-5) in the same manner as those illustrated, but are not shown for simplicity. Together the hardware indicators 502 form an interleaved set of indicators and logic that may blown alternatively to switch between RMA states and SEC (secure) states as the output state 501 as a binary output. The sequencing of the states and the required values for the hardware indicators 502 are illustrated in the table of FIG. 7 in more detail.

The efuses for the hardware indicators 502 and TMM enable 505 may be secured so that only the manufacturer has the capability or authorization to set or “blow” the indicators and thus change the operating state between SEC and RMA or vice versa. For example, authorization certificates may be required by the boot process (or by the operating system at a later point) in order to sign or authorize the alteration of the efuses illustrated in FIG. 5B. Further efuses may be provided or present to define parameters outside the SEC or RMA state. For example, the SEC state may be defined to include activation of certain debug or JTAG ports until a de-activation efuse is blown and the SEC state is locked down fully. Other configurations and efuses may be provided to enhance the variations and control of the parameters for boot states. Furthermore, as is readily apparent, this gating mechanism for boot states and switching between RMA states and SEC states may be applied to any chip with debug ports, JTAG ports or connections that need to be selectively disabled in hardware for security. The illustration of an SoC and its associated features in FIG. 1-2 should not limit the applicability of the TMM or bootstrap controller or related methods provided herein to any other chip or processor.

In FIG. 5C, the internal logic gates of the JTAG logic gates 520 are illustrated according to an implementation. JTAG inputs 521, 523, 525, and 527 on the left side are switched by or dependent on the state 501 that is input from the efuses and logic gates 510 as also illustrated in FIG. 5A. Here the SoC TCK 521 is a test clock signal line, SoC TDI 523 is a test data input line, SoC TMS 525 is a test mode select line, and SoC TRSTN 527 is a test reset line. Other JTAG lines or instructions may also be enabled/disabled in the same way if provided as a part of the chip (e.g. TDO— test data output). The gates on the right may be separately activated by the TMM enable 505 such that during manufacturing and before the TMM is enabled the JTAG ports can be available without being in an RMA state.

In FIG. 5D, the detailed circuitry of the SoC debug logic gates 530 are illustrated according to an implementation. The execution of the at least one instruction in the ROM may process a certificate in the boot storage (e.g., EEPROM). The authenticated certificate may indicate debug/security override policy or may indicate a fuse blowing policy intended by the certificate. The ROM may implement these policies by programming configuration and status registers (CSR) which drive the SCP and SOC debug logic via SCP debug port 534 and SoC debug CSR port 532. Other circuitry and gate logic to perform the enable/disable function based on the state 501 is contemplated including gate logic that does not depend on CSR ports. Additional state data lines may be incorporated into the switching logic of the gate blocks 520 and 530 besides state 501 which indicates SEC or RMA state.

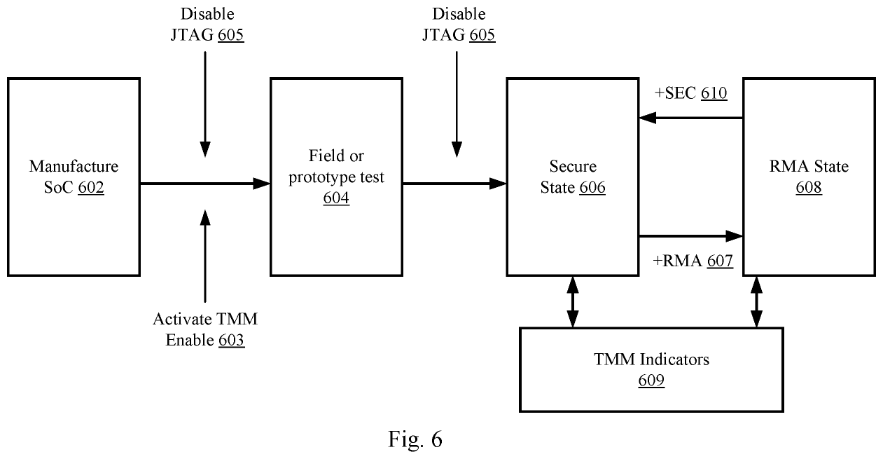

The disclosed hardware indicators 502 allow a chip manufacturer to repeatedly switch between a secure state and an RMA state. The TMM enable flag 505 also provides additional state setting for the manufacturing security conditions of the JTAG and debug ports of the SoC 100. An additional flag may enable/disable JTAG and/or debug ports in a secure state. This additional flag (which could be implemented much like the TMM enable 505 line is implemented in FIG. 5B) may be for JTAG port activation, which may be useful for cloud platform developers at the early stages of development. In FIG. 6, the various intervention points and flows between states is illustrated. First, at 602 the manufacturer may manufacture the SoC 100. After manufacture, the manufacturer may use one or more signing certificates to blow the TMM enable 505 and activate TMM enable at 603. If the SoC is a production version (as opposed to, e.g., an early engineering or test sample), then the JTAG functionality may also be deactivated at this point with the additional JTAG enable flag switched off at 605.

If the SoC 100 or other processor is a field or prototype test article, then the JTAG disable 605 may not occur so that the platform developer may test functionality and integrity of the chip while in a test state that operates like a secure state with JTAG functionality. Then the JTAG disable 605 may be set after testing by the manufacturer or by the platform developer.

After the testing is complete and any additional JTAG enable has been disabled, when the boot strap controller applies voltage to the efuses and logic gates for defining the operating state, a secure state 606 will be defined that is secured by hardware blocks on exploitable test and debug functionality. The secure state 606 may have different variations which are adjustable via TMM indicators 609 which may include hardware indicators 502. Once in the secure state 606, a manufacturer or user with the correct authorization certificate and/or hardware may blow or program an RMA indicator of the hardware indicators 502 to increment RMA 607 (i.e., may blow the next-available RMA indicator as described with respect to FIG. 5B). The boot process and the open ports will then be defined by the RMA state 608. Depending on the needs of the manufacturer during RMA, various test access ports may be enabled when in the RMA state 608. The programming of the RMA indicator may involve a one-time program of a TMM indicator 609 and in order to exit the RMA state 608, a SEC indicator of the TMM indicators 609 will also need to be one-time programmed by SEC increment 610 (i.e., the next-available SEC indicator may be blown as described with respect to FIG. 5B).

The alternating or reciprocal nature of the switches between secure state 606 and RMA state 608 is based on the ordered and alternating increment or one-time programming (OTP) of RMA indicators and SEC indicators of hardware indicators 502. If RMA indicators are incremented twice or SEC indicators are incremented twice, then the bootstrap controller 390 may indicate an invalid state and may output a boot fail flag or fail over into a failsafe mode. Such an invalid state may indicate tampering or unauthorized programming of the OTP indicators. The alternating nature of the state is defined by the XOR logic of the efuses and logic gates 510.

In FIG. 7, the alternating nature of the SEC/RMA increment and the other state are illustrated for additional detail. Specifically, at SoC manufacture 602 the TMM enable flag is not set and so the processor does not enter RMA state or SEC state on boot based on the logic illustrated in FIGS. 5A and 5B. Once the TMM enable 505 flag is set via one-time programming, the processor will boot in a secure state as can be seen by the right-most XOR gate in FIG. 5B. The processor may enter an RMA state upon boot once the first RMA indicator is one-time programmed. This RMA flag or indicator may be programmed by the manufacturer after a customer has returned the processor or SoC. That is, the ability to blow the RMA flags may be reserved for the manufacturer via authorization certificates or the like so that the RMA process cannot be exploited in the field. If no hardware defects are detected by the manufacturer after analysis of the chip (e.g., JTAG scan of the chip) while in the RMA state or if defects can be corrected (e.g., EPROM reflashed), then the manufacturer may correct the issue, program the next SEC flag to return the processor to the secure state.

The manufacturer may then re-ship the processor after one-time programming an SEC indicator. So long as the interleaved indicators connected to the logic gates of the bootstrap controller 390 are programmed in order, the processor will boot into a secure state whenever a SEC indicator is not zero (indicates 1 or TRUE) at the most recently programmed set (pair) of SEC/RMA indicators and no corresponding RMA indicator in the set is also TRUE or non-zero. Likewise, the processor will boot into an RMA state whenever an RMA indicator is not zero at the most recently programmed set (pair) of SEC/RMA indicators.

The invalid state is whenever an RMA indicator has been blown without the SEC indicator of the same pair also being blown or programmed. That is, in this implementation, if an RMA state is to be valid based on a one-time programming of the RMA indicator, then the SEC indicator of the pair must already be blown. This hardware state control illustrated in FIG. 7 enables secure operation of the processor in the field while also allowing an RMA process at the manufacturer if the processor is returned. The process of alternating between states may be implemented for any processor and may be used to enable/disable any ports or pins of a processor. The TMM enable 505 value may be optional for implementations without a system control processor 120 or a SMpro processor 124 or a TMM 210.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. An apparatus for computer security at power-on, the apparatus comprising:
at least two one-time programmable (OTP) indicators including a first programmed OTP indicator;
a bootstrap controller component that controls at least two boot-time switches, the bootstrap controller component calculating an operating state based on the at least two one-time programmable indicators; and
a read only memory storing at least one instruction,
wherein the bootstrap controller component enables or disables an execution of the at least one instruction based on the operating state.

2. The apparatus of claim 1, wherein the at least two one-time programmable indicators are grouped into at least a first subset and a second subset, the first subset being programmed and the second subset being available for one-time programming.

3. The apparatus of claim 1, wherein the first programmed OTP indicator is programmed to enable the bootstrap controller component to initialize at power-on and enter a boot process.

4. The apparatus of claim 2, wherein the second subset of the at least two one-time programmable indicators includes returned merchandise authorization (RMA) state indicators and security state indicators.

5. The apparatus of claim 4, wherein the RMA state indicators and the security state indicators control, via first logic gates, access to debug ports and test access ports for a returned merchandise authorization (RMA) process.

6. The apparatus of claim 1, wherein the bootstrap controller component disables the execution of the at least one instruction based on the operating state.

7. The apparatus of claim 1, wherein the at least two one-time programmable indicators are connected to logic gates, the logic gates being arranged such that a first programming of a first one-time programmable indicator of the at least two one-time programmable indicators is read by the bootstrap controller component as a first state of the operating state and a second programming of a second one-time programmable indicator of the at least two one-time programmable indicators is read by the bootstrap controller component as a second state of the operating state, and a third programming of a third one-time programmable indicator of the at least two one-time programmable indicators is read by the bootstrap controller component as the first state, the third programming being after the second programming.

8. The apparatus of claim 1, wherein the at least two one-time programmable indicators are electronic fuses.

9. The apparatus of claim 1, further comprising:
an interface to one or more test access ports,
wherein programming of a second one-time programmable indicator of the at least two one-time programmable indicators enables or disables the interface to the one or more test access ports.

10. The apparatus of claim 1, wherein execution of the at least one instruction of the read only memory verifies at least one certificate for authenticating firmware code or provides at least one certificate for authenticating firmware code.

11. A method for ensuring computer security at power-on, the method comprising:
reading at least two one-time programmable (OTP) indicators including a first programmed OTP indicator;
determining an operating state for a bootstrap controller component based on the at least two one-time programmable indicators; and
executing at least one instruction based on the operating state.

12. The method of claim 11, wherein the at least two one-time programmable indicators are grouped into at least a first subset and a second subset, the first subset being programmed and the second subset being available for one-time programming.

13. The method of claim 11, wherein the first programmed OTP indicator is programmed to enable the bootstrap controller component to initialize at power-on and enter a boot process.

14. The method of claim 12, wherein the second subset of the at least two one-time programmable indicators includes returned merchandise authorization (RMA) state indicators and security state indicators.

15. The method of claim 14, wherein the RMA state indicators and the security state indicators control, via first logic gates, access to debug ports and test access ports for a returned merchandise authorization (RMA) process.

16. The method of claim 11, wherein the bootstrap controller component disables execution of the at least one further instruction stored in read only memory based on the operating state.

17. The method of claim 11, wherein the at least two one-time programmable indicators are connected to logic gates, the logic gates being arranged such that a first programming of a first one-time programmable indicator of the at least two one-time programmable indicators is read by the bootstrap controller component as a first state of the operating state and a second programming of a second one-time programmable indicator of the at least two one-time programmable indicators is read by the bootstrap controller component as a second state of the operating state, and a third programming of a third one-time programmable indicator of the at least two one-time programmable indicators is read by the bootstrap controller component as the first state, the third programming being after the second programming.

18. The method of claim 11, wherein the at least two one-time programmable indicators are electronic fuses.

19. The method of claim 11, wherein the bootstrap controller component includes an interface to one or more test access ports, wherein programming of a second one-time programmable indicator of the at least two one-time programmable indicators enables or disables the interface to the one or more test access ports.

20. The method of claim 11, wherein execution of the at least one instruction verifies at least one certificate for authenticating firmware code or provides at least one certificate for authenticating firmware code.

21. An apparatus comprising means for:
reading at least two one-time programmable (OTP) indicators including a first programmed OTP indicator;
determining an operating state for a bootstrap controller component based on the at least two one-time programmable indicators; and
executing at least one instruction based on the operating state.

22. The apparatus of claim 21, wherein the at least two one-time programmable indicators are grouped into at least a first subset and a second subset, the first subset being programmed and the second subset being available for one-time programming.

23. The apparatus of claim 21, wherein the first programmed OTP indicator is programmed to enable the bootstrap controller component to initialize at power-on and enter a boot process.
